(19) United States
(12) Patent Application Publication
(10) Pub. No.: US 2020/0323407 A1
(43) Pub. Date: Oct. 15, 2020

(54) WET AND DRY VACUUM BAG WITH CLOSURE SEAL AND RETAINING CLAMP

(71) Applicant: DUSTLESS DEPOT, LLC, Price, UT (US)

(72) Inventor: Kyle Bjork, Buffalo, MN (US)

(73) Assignee: DUSTLESS DEPOT, LLC, Price, UT (US)

(21) Appl. No.: 16/384,648

(22) Filed: Apr. 15, 2019

(51) Int. Cl. A47L 9/14; B01D 46/00

(52) U.S. Cl. CPC A47L 9/1418; A47L 9/1454; B01D 2273/28; B01D 46/0005; B01D 2279/55; A47L 9/1481

(57) ABSTRACT

A vacuum filter bag includes an inlet flange and gasket, a clamp positioned adjacent the inlet flange, and a plug. The clamp is operable to engage the inlet port of a canister vacuum when the filter bag is mounted in the vacuum and keeps the filter bag securely attached to the vacuum inlet. The clamp is also operable to engage the plug and keep the plug in place to close the filter bag inlet after use of the bag. The filter bag reduces user exposure to dust and debris captured with a canister vacuum.

### THE FIELD OF THE INVENTION

The present invention relates to vacuum bags. In particular, examples of the present invention relates to a system for closing a vacuum bag after use and for retaining the vacuum bag on the vacuum during use.

### BACKGROUND

Vacuums are commonly used to clean up dust and debris. As a vacuum moves a substantial amount of air in order to entrain and capture dust and debris, it requires adequate filtration to remove the dust from the air. As people become increasingly aware of the health hazards of many airborne particulates, there is an increasing demand for vacuums and vacuum filters which are better able to capture dust and thereby minimize the exposure to the dust.

### BRIEF DESCRIPTION OF THE DRAWINGS

Non-limiting and non-exhaustive examples of the present invention are described with reference to the following figures, wherein like reference numerals refer to like parts throughout the various views unless otherwise specified.

FIG. 1 is a schematic drawing which shows a vacuum and filter bag.

FIG. 2 is a drawing which shows an enlarged view of the vacuum inlet and filter bag.

FIG. 3 is a front view drawing of the filter bag.

FIG. 4 is a front view drawing of the filter bag inlet flange.

FIG. 5 is a front view drawing of the filter bag inlet flange.

FIG. 6 is a back view drawing of the filter bag inlet flange.

FIG. 7 is an isometric drawing of a portion of the filter bag.

FIG. 8 is an isometric drawing of a portion of the filter bag.

FIG. 9 is an isometric drawing of a portion of the filter bag.

FIG. 10 is a right side view drawing of a portion of the filter bag.

FIG. 11 is a right side view drawing of a portion of the filter bag.

FIG. 12 is a right side view drawing of a portion of the filter bag.

FIG. 13 is a left side view drawing of the inlet flange.

FIG. 14 is a top view drawing of the inlet flange.

FIG. 15 is a bottom view drawing of the inlet flange.

FIG. 16 is a front view drawing of an alternate design of the inlet flange.

FIG. 17 is a front view drawing of an alternate design of the inlet flange.

FIG. 18 is a front view drawing of an alternate design of the inlet flange.

FIG. 19 is a front view drawing of an alternate design of the inlet flange.

Corresponding reference characters indicate corresponding components throughout the several views of the drawings. Unless otherwise noted, the drawings have been drawn to scale. Skilled artisans will appreciate that elements in the figures are illustrated for simplicity and clarity. For example, the dimensions of some of the elements in the figures may be exaggerated relative to other elements to help improve understanding of various examples of the present invention. Also, common but well-understood elements that are useful or necessary in a commercially feasible embodiment are often not depicted in order to facilitate a less obstructed view of these various embodiments of the present invention.

It will be appreciated that the drawings are illustrative and not limiting of the scope of the invention which is defined by the appended claims. The examples shown each accomplish various different advantages. It is appreciated that it is not possible to clearly show each element or advantage in a single figure, and as such, multiple figures are presented to separately illustrate the various details of the examples in greater clarity. Similarly, not every example need accomplish all advantages of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

In the above disclosure, reference has been made to the accompanying drawings, which form a part hereof, and in which are shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be used in connection with other embodiments whether or not explicitly described. The particular features, structures or characteristics may be combined in any suitable combination and/or sub-combinations in one or more embodiments or examples. It is appreciated that the figures provided herewith are for explanation purposes to persons ordinarily skilled in the art.

The disclosure describes a vacuum filter. Particularly, the present disclosure describes a vacuum filter for canister vacuums with a retaining clamp to secure the filter to the vacuum inlet. The retaining clamp also secures a plug into the filter opening after use of the filter. The plug closes the filter inlet and prevents loss of particulate matter or other collected debris through the filter opening.

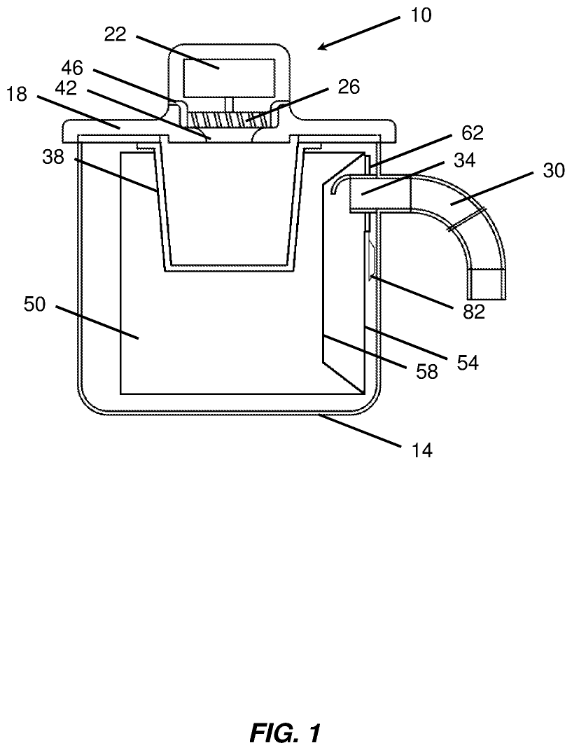

Vacuums, such as portable canister vacuums (e.g. shop vacuums), are commonly used to collect debris. As people become increasingly aware of the health hazards of airborne particulates generated during construction work, canister vacuums are becoming commonly used for cleanup and also to capture the dust and debris generated from power tools. Vacuums may be connected to power tool dust shrouds to directly collect the dust as it is generated at the power tool. Vacuums are often used to capture any other dust and debris encountered during the work. Referring to FIG. 1, a schematic drawing of a canister vacuum 10 is shown. These types of vacuums 10 typically have a canister 14, which often has a volume from 1 to 15 or more gallons, and a canister lid 18. The canister lid 18 typically contains the vacuum motor 22 and impeller/fan 26. Air moves through a vacuum hose 30, through a canister inlet 34, and into the canister 14. The air then moves through a filter 38, a lid inlet 42, the motor fan 26, and out of the vacuum 10 through an exhaust opening 46 in the lid 18. The filter 38 is used to remove debris which is entrained in the moving air and trap the debris in the vacuum canister 14 so that clean air flows out of the vacuum 10. The filter 38 is commonly cylindrical or conically shaped and may attach to the vacuum canister lid 18 so that any air passing through the vacuum impeller 26 also passes through the filter 38.

A bag filter 50 is attached to the canister inlet 38 to improve the filtration ability of the vacuum 10. Accordingly, air flows through the hose 30 and into the bag filter 50, through the bag filter 50, through the filter 38, and out of the vacuum 10. The use of a bag filter 50 is advantageous when the vacuum 10 is used to capture fine dust as it provides a significantly larger filter area which is not easily clogged. The bag filter 50 also keeps the cylindrical filter 38 from clogging and maintains good air flow through the vacuum 10. The bag filter 50 is particularly advantageous for collecting hazardous dust such as fiberglass, sheetrock dust, cement dust, debris containing asbestos or lead, and other construction dusts. As people become more aware of the harmful effects of breathing dusts, more people desire to minimize their exposure to airborne dusts. Without a bag filter 50, debris collects in the canister 14 during use. The fine dust collects on the cylindrical filter 38. The vacuum 10 is emptied by removing the lid 18, dumping out the canister 14, and removing the filter 38. The filter 38 may be disposed of or may be knocked clean and reused. Emptying the vacuum canister 14 and cleaning the filter 38 expose the user to significant amounts of dust and allow dust to escape into the environment. The user is likely to inhale some dust while emptying the vacuum 10. This is particularly undesirable where the dust is harmful to the lungs. The use of a bag filter 50 solves many of these problems as the dust is captured in the bag filter 50. The vacuum canister 14 and the canister filter 38 largely remain clean.

Existing bag filters, however still suffer from some drawbacks which expose the user to dust. Existing vacuum bags have a heavy paper inlet flange with a rubber gasket. The gasket is flat rubber with a hole which is smaller than the vacuum inlet. The bag is placed in a “C” shape in the vacuum canister and the inlet flange is placed over the vacuum inlet so that the inlet extends through the gasket. In some cases, these existing vacuum bag filters fall off of the canister inlet during use. Where heavy debris such as sheetrock or concrete dust is collected in the vacuum, the weight of the debris may pull the inlet flange off of the vacuum inlet. If this happens, dust collects outside of the bag in the vacuum canister, on the outside of the vacuum bag filter, and on the canister filter. If a canister filter is not used with the bag filter, unfiltered air passes through the vacuum motor and out of the vacuum. Emptying the vacuum then exposes the user to a significant amount of dust on the outside of the bag.

Even if the bag filter does not fail during use, a significant amount of dust may be expelled out the inlet of the bag filter as the bag is handled. Movement of the bag to remove it from the vacuum and deposit it in the garbage tends to pump air in and out of the vacuum bag. This air movement entrains dust from the filter bag and pumps dust out of the vacuum bag; exposing the user who is handling the bag to the dust.

The present vacuum bag 50 addresses these problems by providing an inlet clamp and plug. The clamp secures the bag 50 to the vacuum inlet 34 during use and ensures that dust is properly collected in the filter bag 50. Once the filter bag is ready for disposal, the plug is used to close the inlet opening into the filter bag 50. The clamp is used to secure the plug in the inlet opening so that dust is not expelled out of the bag while the bag is handled by the user.

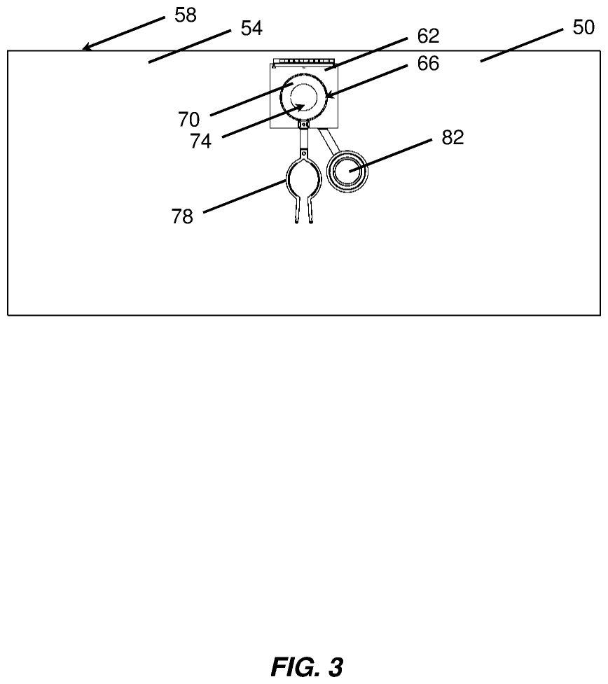

FIG. 3 shows a drawing of the filter bag 50. The filter bag 50 includes a front layer 54 and a back layer 58 of material. The front layer 54 and back layer 58 of material are part of the enclosed envelope of the filter bag. In many applications, the front layer 54 is a layer of filter media and the back layer 58 is a layer of filter media. In some situations, either the front layer 54 or the back layer 58 may comprise filter media. In some vacuums 10, the air flow through a filter bag 50 is predominantly through one side or section of the filter bag 50 and the other sections of the filter bag 50 contribute little to the airflow. For example, most of the airflow through filter bags 50 in canister vacuums 10 is through the inside of the filter bag 50 (the back layer 58 of the filter bag) as the front layer 54 of the filter bag 50 is disposed against the wall of the canister 14 and the back layer 58 of the filter bag is disposed adjacent the cylindrical filter 38 or the motor inlet. Accordingly, the filter bag 50 may be formed with a front layer 54 of relatively impermeable material for greater strength or reduced cost and with a back layer 58 of filter media. The filter media is a depth filtration media such as filter paper, filter cloth, or filter felt. The edges of the front layer 54 and back layer 58 of filter media are sealed together to form an envelope for collecting dust and debris. Filter bags 50 are often about 3 feet wide and about 2 feet tall; providing a significant amount of filter area. The filter bags 50 may range between about 4 and about 2 feet wide and between about 1 and about 2 feet tall. An inlet flange 62 (a filter mounting flange 62) is attached to the front layer 54 of filter media. The inlet flange 62 includes an opening 66 which is larger in diameter than the vacuum inlet 34. An inlet gasket 70 is attached to the inlet flange 62 in the opening 66. The inlet gasket 70 provides a smaller opening 74 which is smaller in diameter than the vacuum inlet 34. A corresponding filter media opening is located in the front layer 54 of filter media to allow the vacuum inlet 34 to pass through the inlet flange 62 and into the interior of the filter bag 50. A clamp 78 and a plug 82 are attached to the inlet flange 62.

As is shown in FIG. 1, the vacuum filter bag 50 is installed in the vacuum 10. FIG. 1 is shown in cross-section and is simplified to more easily show the overall vacuum and filter components. Some necessary components, such as a vacuum power cord or power source are not shown for simplicity. The filter bag 50 has been unfolded and placed into the vacuum canister 14 in a “C” shape around the vacuum canister perimeter as viewed from above. The front layer 54 of filter media is facing the outside of the vacuum canister 14 so that the inlet flange 62 is disposed on the outside of the filter bag 50 adjacent the vacuum inlet 34. The filter inlet flange 62 is attached to the vacuum inlet 34 so that the vacuum inlet 34 extends through the inlet flange 62 and into the interior of the filter bag 50.

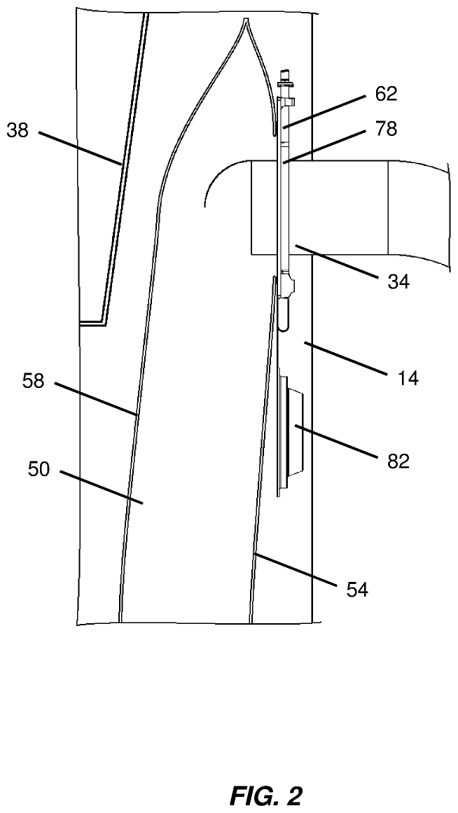

FIG. 2 shows a more detailed drawing of the vacuum inlet 34 and filter inlet flange 62. The vacuum inlet 34 extends through the inlet flange 62 and into the interior of the filter bag 50. The vacuum inlet 34 passes through the inlet flange opening 66 and through the opening 74 in the inlet gasket 70. The inlet gasket 70 is made from an elastic material and stretches to accept the vacuum inlet 34 and seals around the vacuum inlet 34. The inlet gasket 70 may be made from rubber or molded from an elastomer such as a thermoplastic elastomer. While the filter bag 50 is installed in the vacuum 10, the plug 82 is not used to seal the inlet opening 74. The clamp 78 is used to secure the filter bag inlet flange 62 to the vacuum inlet 34. The clamp 78 grips the vacuum inlet 34 and keeps the filter inlet flange 62 from sliding off of the vacuum inlet 34 due to vibration, movement of the vacuum 10 during transport or use, or accumulation of weight in the filter bag 50.

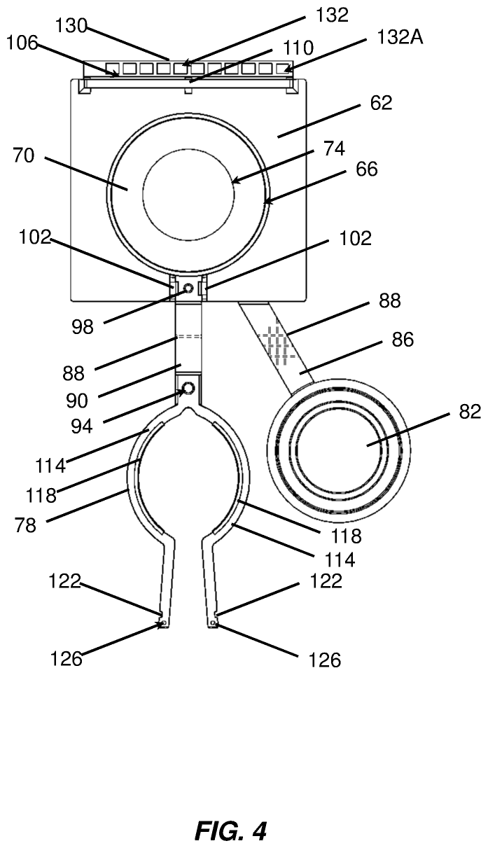

FIG. 4 shows a front view of the filter inlet/mounting flange 62. For clarity in showing the structures of the filter inlet flange 62, the front layer 54 and back layer 58 of filter media are not shown. It is understood that these structures are present as shown in other figures such as FIGS. 1, 2, and 3. Similarly, other figures may show only a portion of the remainder of the filter bag 50 to better illustrate the inlet flange 62.

The inlet flange 62 is shown in a design which may be easily and inexpensively molded. The inlet flange may be molded from a thermoplastic material. The plug 82 is attached to the inlet flange 62 by a flexible strap 86. The strap 86 allows the plug 82 to bend upwardly towards the inlet opening 74 after use of the filter bag 50 to plug the inlet opening 74. The strap 86 is often about 0.5 inches wide and about 0.02 inches thick. The clamp 82 is attached to the inlet flange 62 by a flexible strap 90. The strap 90 allows the clamp 78 to bend upwardly to a position where the clamp 78 surrounds the inlet opening 74. In this position, the clamp 78 is disposed parallel to and adjacent to the inlet flange 62. The base of the clamp 78 adjacent to the strap 90 includes an alignment hole 94. A corresponding alignment pin 98 is formed in the inlet flange 62. Two retention flanges/clips 102 are also formed in the inlet flange 62. The retention clips 102 extend upwardly from the inlet flange and are “L” shaped with locking distal ends which present a narrower width than the width of the base of the clamp 78. When the clamp 78 is bent upwardly into position against the inlet flange 62, the alignment pin 98 is inserted into the alignment hole 94 and the retention clips 102 engage and retain the base of the clamp 78. This secures the clamp 78 in position adjacent the inlet flange 62.

Both the plug strap 86 and the clamp strap 90 may be formed with a section of living hinge, indicated in example at 88. The living hinge 88 may include a series of holes in the strap so that the living hinge section of the strap includes a mesh of interconnected strips of material. Alternatively, the living hinge 88 may include a section of reduced material thickness in the strap 86, 90. The living hinge 88 may be formed with radiused corners and edges so that material stress is minimized while bending the living hinge 88. The living hinge 88 thereby provides an increase in flexibility for the strap 86, 90 and allows a user to more easily bend the strap 86, 90 and allows the strap 86, 90 to accept repeated bending without breaking.

Additionally, the inlet flange 62 includes a guide slot 106 which is formed between the inlet flange 62 and a guide rail 110. The guide rail 110 is attached to the inlet flange 62 and spaced apart from the face of the inlet flange 62 by standoff posts to create the guide slot 106 between the guide rail 110 and the inlet flange 62. The clamp 78 is positioned in the guide slot 106 while it is being used and the guide slot 106 secures the top of the clamp 78 and holds it against the inlet flange 62. The clamp 78 includes two clamp arms 114 which extend from the base of the clamp 78. The clamp arms 114 include curved sections which are positioned around the vacuum inlet 34 during use. The clamp arms 114 also include straight distal sections which extend beyond the curved sections and provide a location for a user to manipulate the clamp 78 and to secure the clamp 78 around the vacuum inlet 34 or the plug 82. The clamping arms 114 include a clamping face 118 which is formed from a softer material than the rest of the clamping arms 114. In the example inlet flange 62, the clamping arms 114 are formed from a relatively rigid plastic which allows clamping force to be applied to the vacuum inlet 34 or plug 82 and the clamping faces 118 are formed from a less rigid material such as a thermoplastic elastomer which provides increased grip on the vacuum inlet 34 or the plug 82. The distal ends of the clamping arms 114 include notches 122 and holes 126 which allow the clamp 78 to be secured to the vacuum inlet 34 or plug 82. The notches 122 are used in combination with a strap 130 to secure the clamp 78. The example strap 130 is molded in combination with the inlet flange 62. The strap 130 is connected to the inlet flange 62 by small bridges of material (e.g. mold sprues) which may be broken by a user to disconnect the strap 130 from the inlet flange 62. The strap 130 is formed with holes 132 along its length. The holes 132 receive the distal ends of the clamping arms 114 and engage the notches 122. An end hole 132A may be smaller than the remaining holes 132 so that the end hole 132A fits more tightly around the distal end of a clamping arm 114. This end hole 132A may be sized so that the strap 130 is stretched slightly to place the end of a clamping arm 114 into the hole and so that the notch 122 is held securely in the hole 132A; increasing the security and usability of the strap 130 and clamp 78. During use of the strap 130, one clamping arm 114 and notch 122 is engaged with the end hole 132A and the other clamping arm 114 and notch 122 is engaged with another hole 132. A plurality of holes 132 are provided along the length of the strap 130 to allow the clamp 78 and strap 130 to accommodate different sizes of vacuum inlets 34. The holes 126 in the clamping arms 114 may be used in combination with a small zip tie or metal wire to close the clamp more permanently (usually around the plug 82) or in the event that the strap 130 is lost.

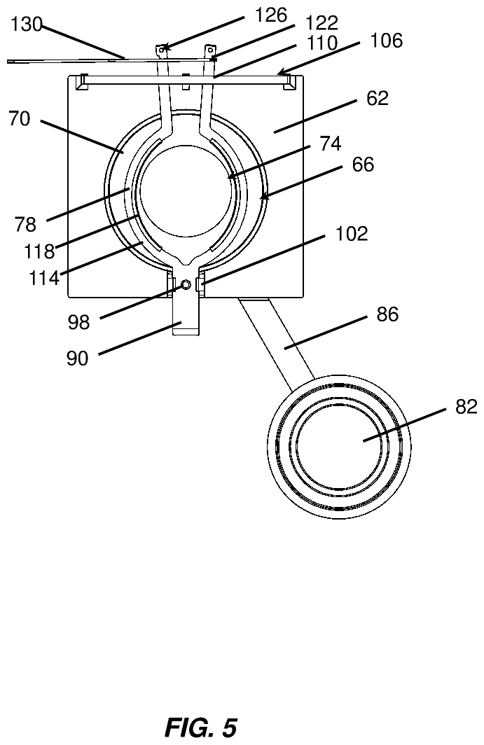

FIG. 5 shows the vacuum bag inlet flange 62 with the clamp 78 in a ready-to-use position. From the molded state of the inlet flange 62, the clamp 78 is moved upwardly by bending the strap 90 until the clamp 78 is adjacent the face of the inlet flange. The distal ends of the clamping arms 114 are inserted through the guide slot 106 and the base of the clamp 78 is pressed against the inlet flange 62 so that the alignment pin 98 is inserted into the alignment hole 94 and the base of the clamp 78 is secured between the clips 102. The clamp 78 is then held adjacent the face of the inlet flange 62. When the vacuum filter bag 50 is installed in a vacuum, the strap 130 is used to hold the distal ends of the clamp arms 114 together so that the arms 114 grip the vacuum inlet 34 (or similarly the plug 82).

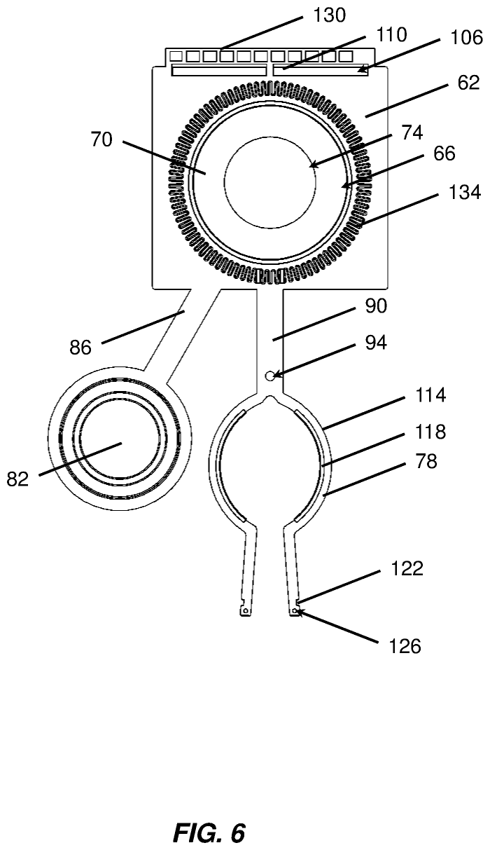

FIG. 6 shows a back side of the inlet flange 62. This side of the inlet flange 62 is attached to the front layer 54 of the filter bag 50. The inlet flange 62 includes an undulating groove/ridge 134 molded in the back side. This groove/ridge 134 is where glue is applied to bond the inlet flange 62 to the front layer 54 of the filter bag 50 and the groove/ridge 134 provides an increase in surface area and surface roughness to improve the glue bonding.

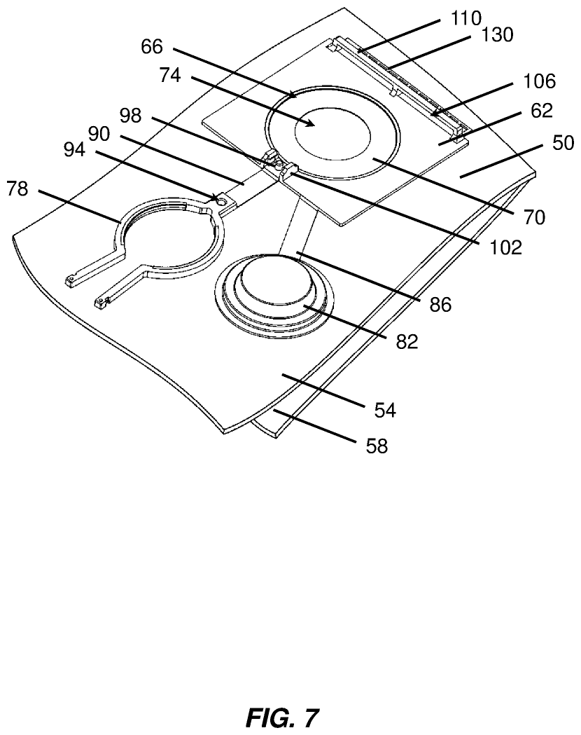

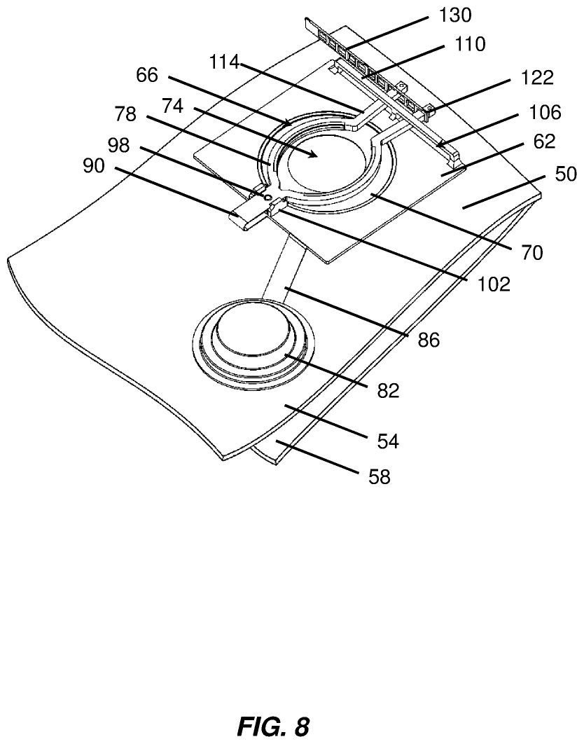

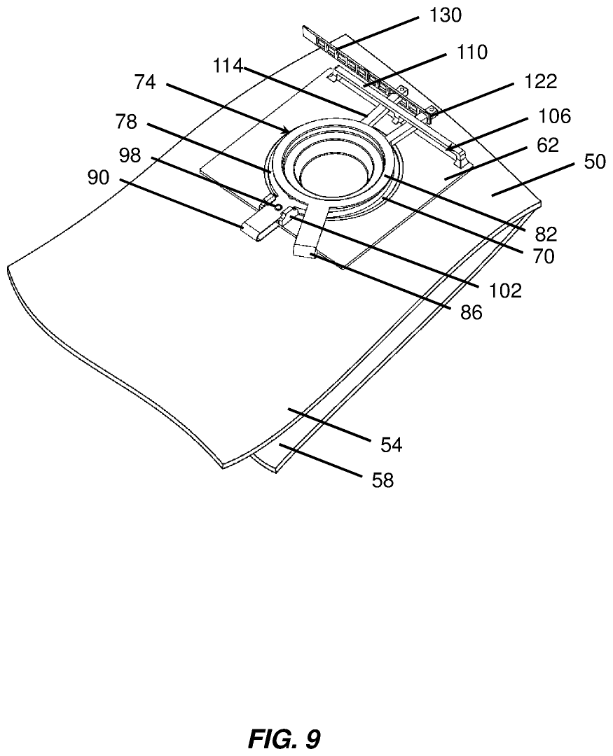

FIGS. 7, 8, and 9 show drawings of the portion of the filter bag 50 surrounding the inlet flange 62. All of the filter media is not shown to improve the visibility of the inlet flange 62. FIG. 7 shows the filter bag 50 with the inlet flange 62 in an “as manufactured” state. FIG. 8 shows the filter bag 50 with the clamp 78 moved into a position where it is ready for use in a vacuum 10. FIG. 9 shows the filter bag 50 with the plug 82 inserted into the inlet hole 74 and with the inlet clamp 78 securing the plug 82. In this state, the filter bag 50 is ready for disposal.

If the filter bag 50 is provided to a user in the state shown in FIG. 7, the clamp 78 and the plug 82 both are flat with respect to the filter material and the inlet flange 62. The vacuum bag 50 may be folded and easily stored and shipped. If provided in this state, a user will move the clamp 78 upwardly by bending the strap 90 until the clamp 78 is adjacent the face of the inlet flange. The user will then insert the distal ends of the clamping arms 114 through the guide slot 106 and press the base of the clamp 78 against the inlet flange 62 so that the alignment pin 98 is inserted into the alignment hole 94 and the base of the clamp 78 is secured between the clips 102. The user may then cut or break the strap 130 free from the inlet flange 62. The filter bag 50 is then in the state shown in FIG. 8 and is ready for installation into a vacuum 10.

The user will then place the vacuum filter bag 50 into a vacuum canister 14 and place the inlet flange 62 over the vacuum inlet 34 so that the vacuum inlet 34 protrudes through the filter inlet hole 74. The inlet gasket 70 seals against the vacuum inlet 34. The user then presses the ends of the clamp arms 114 together and uses the strap 130 to hold the distal ends of the clamp arms 114 together so that the arms 114 grip the vacuum inlet 34. The vacuum filter bag 50 is now ready for the user to use the vacuum 10 to collect debris. The clamp 78 helps ensure that the filter bag 50 is not dismounted from the vacuum inlet 34 during use of the vacuum. This provides an important measure of safety when the vacuum 10 is used to collect harmful dust.

The filter bag 50 will often be removed from the vacuum 10 and be discarded. This often occurs when the filter bag 50 is full and collection of additional dust and debris is impeded. Additionally, this may occur when collection of a harmful material has been completed and the worker desires to discard the filter bag 50 to minimize any potential for exposure to the material. When a user desires to discard the filter bag 50, they will discontinue use of the vacuum 10. The user will then open the vacuum 10 and remove the strap 130 from the clamp arms 114 to release the clamp arms 114 from the vacuum inlet 34. The inlet flange 62 is then carefully slid off of the vacuum inlet 34. Before removing the filter bag 50 from the vacuum canister 14, the user places the plug 82 into the filter inlet opening 74 by bending the flexible strap 86 as the plug 82 is moved and rotated upwardly to the inlet opening 74. The plug 82 is placed into the inlet opening 74 to close the inlet opening 74. The user then presses the ends of the clamp arms 114 together so that the clamp 78 grips the plug 82 and uses the strap 130 to secure the plug 82 within the clamp 78. Alternately, the user may use a zip tie or metal wire to more permanently secure the clamp 78 around the plug 82. This places the filter bag 50 into the state shown in FIG. 9. The inlet opening 74 of the filter bag 50 is easily and reliably plugged before removal from the vacuum canister 14. With the plug 82 secured in the inlet hole 74, the user may then remove the filter bag 50 from the vacuum canister 14 and discard the filter bag 50 with minimal risk of exposure to the material collected in the filter bag 50. Air movement into or out of the filter bag 50 due to handling is through the filter material 54, 58 because the inlet hole 74 is blocked.

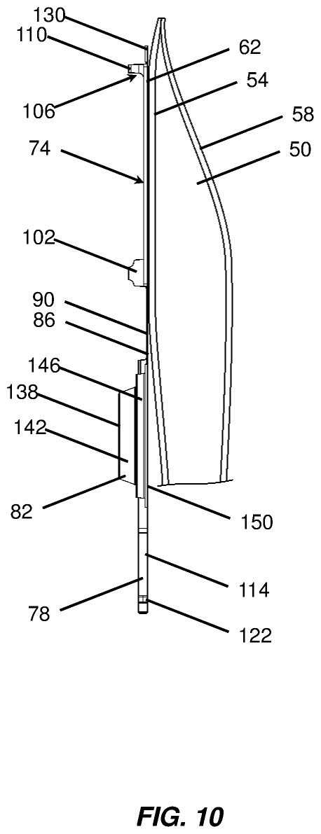

FIG. 10 shows a partial drawing of the right side of the inlet flange 62. For clarity, most of the filter media 54, 58 is not shown. The filter media 54, 58 is positioned on the right side of the inlet flange 62 and the left side of the inlet flange 62 is exposed and is mounted to the vacuum inlet 34. The inlet flange 62 is shown in the “as manufactured” state as shown in FIG. 4 and FIG. 7. The clamp 78 and plug 82 are generally planar with the inlet flange 62 and lie flat on the folded filter bag 50. This drawing more clearly shows how the clips 102 extend outwardly from the inlet flange 62. The guide rail 110 also is positioned outwardly from the inlet flange 62 to form the guide slot 106. To prepare the filter bag 50 for use, the clamp 78 is moved upwardly by bending the strap 90 until the clamp 78 is adjacent the face of the inlet flange 62 and the distal ends of the clamping arms 114 extend through the guide slot 106. The base of the clamp 78 is secured against the inlet flange 62 by the alignment pin 98, alignment hole 94, and the clips 102. The strap 130 is freed from the inlet flange 62 for use with the clamp 78.

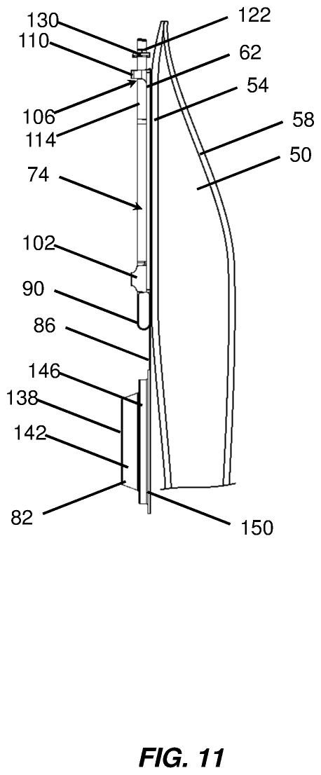

FIG. 11 shows a partial drawing of the right side of the inlet flange 62 with the filter bag 50 ready for installation into a vacuum 10. FIG. 11 also shows the shape of the plug 82 more clearly. The plug 82 includes an end face 138 which passes through the filter inlet opening 74 when the plug 82 is used to close the filter bag 50. The plug 82 also includes a chamfered shoulder 142. The chamfered shoulder 142 includes a smaller distal diameter which is smaller than or close to the diameter of the filter inlet opening 74. The chamfered shouldered 142 includes a larger proximal diameter which is larger than the filter inlet opening 74. As the plug 82 is used to close the filter inlet opening 74, the smaller distal end of the chamfered shoulder 142 passes into the filter inlet opening 74 and the filter inlet gasket 70 engages the chamfered shoulder 142 and seals against the chamfered shoulder 142 between the distal and proximal ends of the chamfered shoulder 142. The plug 82 also includes a clamping shoulder 146 which is larger in diameter than the chamfered shoulder 142. The clamping shoulder 146 is received into the clamp 78 when the plug 82 is used to close the filter bag opening 74 and the clamp arms 114 are tightened against the clamping shoulder 146 to secure the plug 82. A flange 150 extends outwardly from the proximal end of the clamping shoulder 146. The flange 150 keeps the plug 82 from passing through the clamp 78 towards the vacuum bag 50.

When the vacuum filter bag 50 is placed into a vacuum canister 14, the inlet flange 62 is placed over the vacuum inlet 34 so that the vacuum inlet 34 protrudes through the filter inlet opening 74 as is shown in FIGS. 1 and 2. The inlet gasket 70 seals against the vacuum inlet 34. The ends of the clamp arms 114 are pressed together around the vacuum inlet 34 and the strap 130 is used to hold the distal ends of the clamp arms 114 together so that the clamp arms 114 grip the vacuum inlet 34.

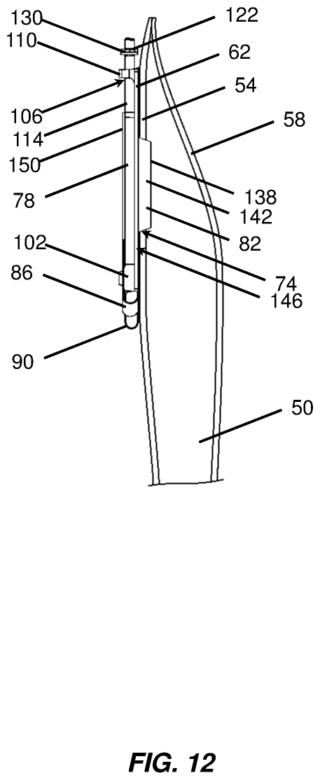

When the filter bag 50 is removed from the vacuum 10, the strap 130 is removed from the clamp arms 114 to release the clamp arms 114 from the vacuum inlet 34. The inlet flange 62 is moved off of the vacuum inlet 34 and the plug 82 is placed into the filter inlet opening 74 by bending the flexible strap 86 as the plug 82 is moved and rotated upwardly to the inlet opening 74. The plug 82 closes the filter inlet opening 74. The ends of the clamp arms 114 are pressed together so that the clamp 78 grips the plug 82 and the strap 130 is used to secure the plug 82 within the clamp 78. FIG. 12 shows the filter bag 50 ready for disposal with the plug 82 disposed in the filter inlet opening 74. The clamp 78 is positioned around the clamping shoulder 146 and the flange 150 is positioned against the clamp 78. The plug distal end face 138 and the distal end of the chamfered shoulder 142 have passed through the inlet gasket 70 and are disposed in the vacuum bag 50. The filter inlet gasket 70 seals against the chamfered shoulder 142.

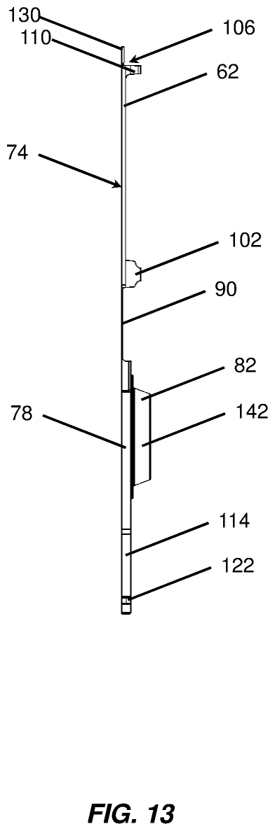

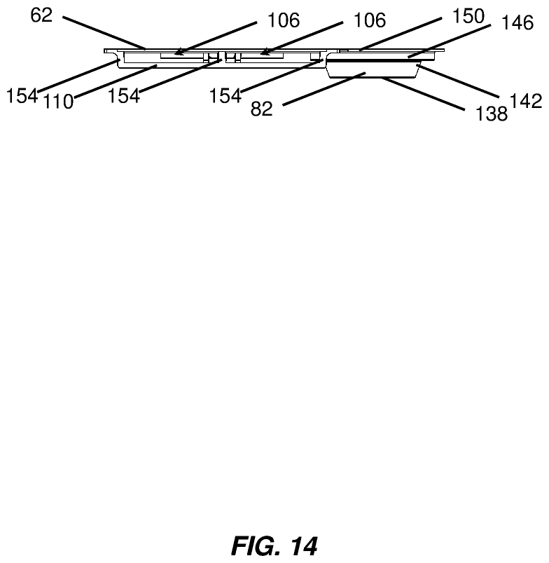

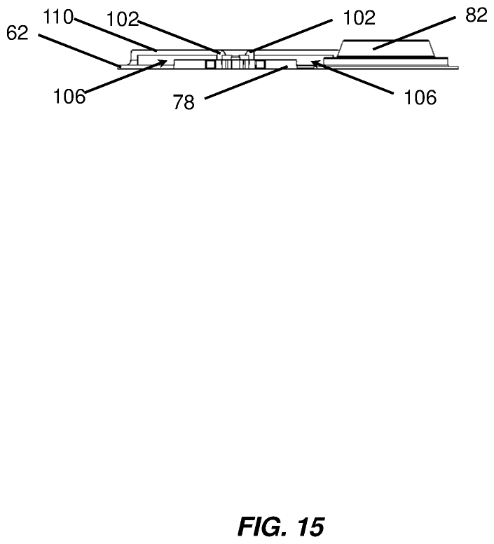

FIG. 13 shows a left side drawing of the inlet flange 62. The filter media is not shown. FIG. 14 shows a top view of the inlet flange 62. The filter media is not shown. The guide rail 110 is spaced apart from the body of the inlet flange 62 to form the guide slot 106. The guide rail is connected to the inlet flange 62 by standoff posts 154. The example inlet flange 62 includes two standoff posts 154 at the ends of the guide rail 110 and one standoff post 154 at the center of the guide rail 110 to strengthen the guide rail 110 against bending away from the inlet flange 62. This allows the guide rail 110 to hold the clamp 78 securely in a position adjacent the inlet flange 62 during use. FIG. 15 shows a bottom view of the inlet flange 62 without the filter media. The retention clips 102 are visible, showing how the retention clips have “L” shaped ends which snap around the base of the clamp 78 and hold the clamp 78 adjacent the inlet flange during use.

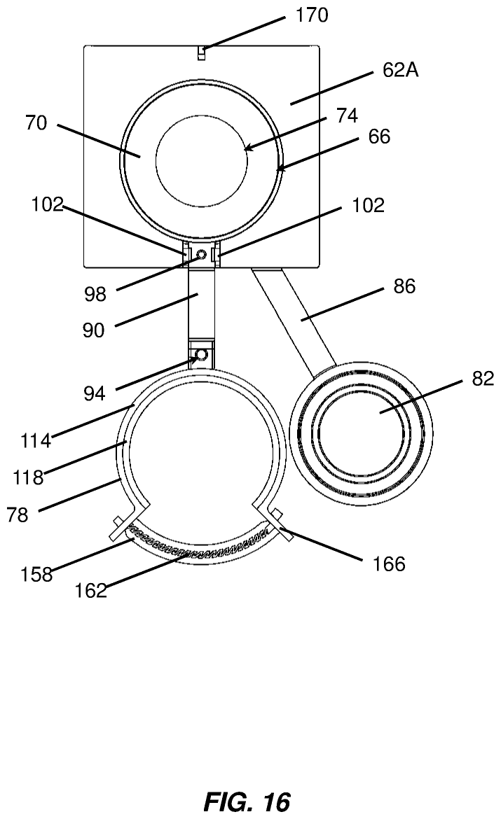

FIG. 16 shows an alternate embodiment of the inlet flange 62A. Unless otherwise noted, the inlet flange 62A includes the same structures and functionality noted above. The inlet flange 62A differs in the design of the clamp 78. The clamp 78 includes clamping arms 114 which function as discussed above. The distal ends of the clamping arms 114 are attached to a ratcheting closure mechanism. One clamping arm 114 is attached to a curved ratchet strap 158 which includes a series of angled steps 162 along its length. The other clamping arm 114 is attached to a ratchet body 166 which engages the angled steps 162 to hold the ratchet in a closed position. The ratchet strap 158 passes through an opening in the ratchet body 166. The ratchet clamp may function similar to a zip tie. A user may use the clamp by pressing the ends of the clamping arms 114 together to engage the vacuum inlet 34 or the plug 82. The ratchet clamp structure 158, 162, 166 holds the clamping arms 114 together in the desired position. The ratchet body 166 may include a lever to release the ratchet strap 158, or may allow the ratchet strap 158 to slide sideways within the ratchet body 166 to release the ratchet clamp. This allows the user to release the clamp 78 from the vacuum inlet 34 and then use the clamp 78 to grip the plug 82. The inlet flange 62A includes a retention clip 170 at its top end. The retention clip 170 may have a shape similar to retention clips 102 and engages the ratchet strap 158 (or alternately the ends of the clamping arms 114) to hold the clamp 78 against the inlet flange 62A during use. The inlet flange 62A may be prepared for use by moving the clamp 78 upwardly by bending the strap 90 until the clamp 78 is adjacent the face of the inlet flange. The clamp 78 is then pressed against the inlet flange 62A so that the distal end of the clamp 78 (e.g. the ratchet strap 158) is held by the retention clip 170, so that the alignment pin 98 is inserted into the alignment hole 94, and so that the base of the clamp 78 is secured between the retention clips 102.

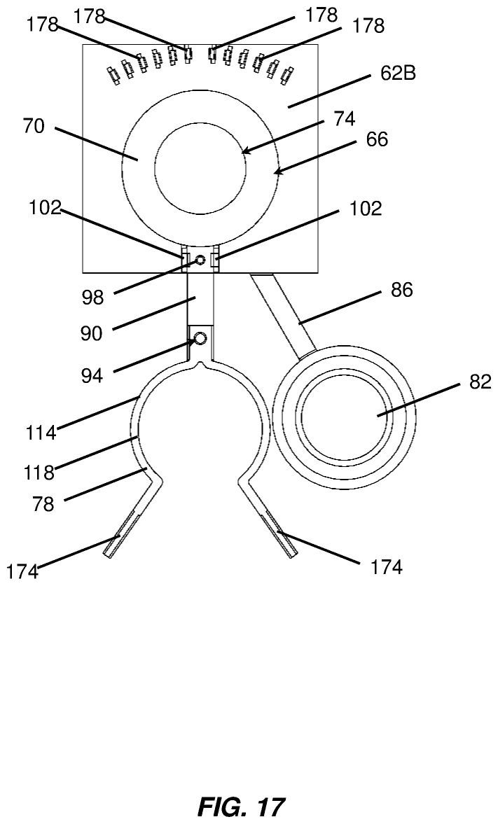

FIG. 17 shows an alternate embodiment of the inlet flange 62B. Unless otherwise noted, the inlet flange 62B includes the same structures and functionality noted above. The inlet flange 62B differs in the design of the clamp 78. The clamp 78 includes clamping arms 114 which function as clamps as discussed above. The clamping arms 114 include elongate distal ends 174. The inlet flange 62B may be prepared for use by moving the clamp 78 upwardly by bending the strap 90 until the clamp 78 is adjacent the face of the inlet flange 62B. The clamp 78 is then pressed against the inlet flange so that the alignment pin 98 is inserted into the alignment hole 94 and the base of the clamp 78 is secured between the retention clips 102. The clamp is used by pressing the distal ends 174 of the clamping arms 114 together so that the clamping arms engage the vacuum inlet 34 or the plug 82. The distal ends 174 of the clamping arms 114 are then engaged with retention posts 178 on the inlet flange 62B. The retention posts 178 include a post which extends out of the face of the inlet flange 62B and a laterally extending “L” shaped end which retains the clamping arms 114. The user presses the distal ends 174 of the clamping arms 118 together and then nests them against the two retention posts 178 which hold the clamping arms 114 in the desired position. The clamping arms 114 may be disengaged from the retention posts 178 by pressing them together and bringing them out of contact with the retention posts 178. The clamp 78 may be used to alternately hold the vacuum inlet 34 or the plug 82.

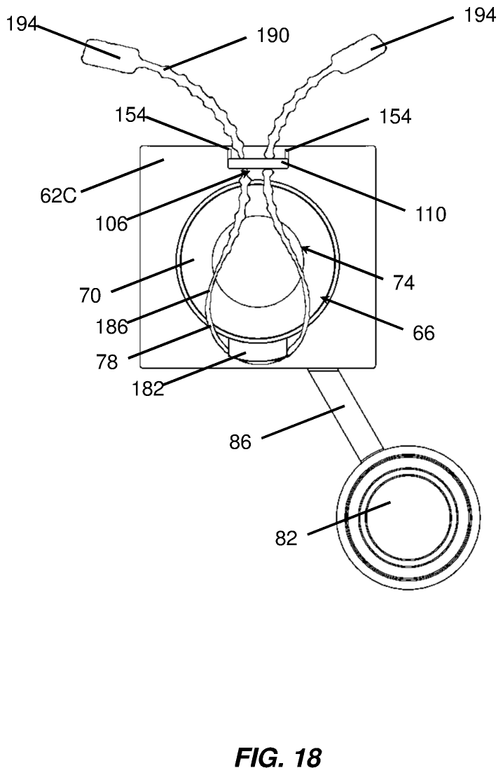

FIG. 18 shows an alternate embodiment of the inlet flange 62C. Unless otherwise noted, the inlet flange 62C includes the same structures and functionality noted above. The inlet flange 62C differs in the design of the clamp 78. The inlet flange 62C includes a guide rail 110 attached to the inlet flange 62C by standoff posts 154 to create a guide slot 106 between the inlet flange 62C and the guide rail 110. The inlet flange 62C also includes a retention bracket 182 attached to the bottom of the inlet flange 62C adjacent the inlet flange opening 66. The retention bracket 182 extends away from the face of the inlet flange and includes an “L” shaped distal end with an end tab extending downwardly away from the inlet flange opening 66. The clamp 78 includes an elastomeric clamping strap 186. The elastomeric clamping strap 186 includes a plurality of enlarged beads 190 formed along its length and includes distal ends 194 with finger grips. The elastomeric clamping strap 186 passes through the guide slot 106, around the retention bracket 182, and back through the guide slot 106 so that it loops around the filter inlet opening 74. The guide slot 106 may be narrower in width than the beads 190 so that a user may pull the ends 194 of the clamping strap 186 through the guide slot by deforming the beads 190. In this manner, the elastomeric clamping strap 186 may be tightened around the vacuum inlet 34 or the plug 82 as desired. The guide slot 106 may be formed with narrowed ends so that the elastomeric clamping strap beads 190 fit more easily through a wider section in the middle of the guide slot 106 and are gripped by the narrowed lateral ends of the guide slot 106 when the elastomeric clamping strap 186 is moved to the ends of the guide a lot 106 by a user.

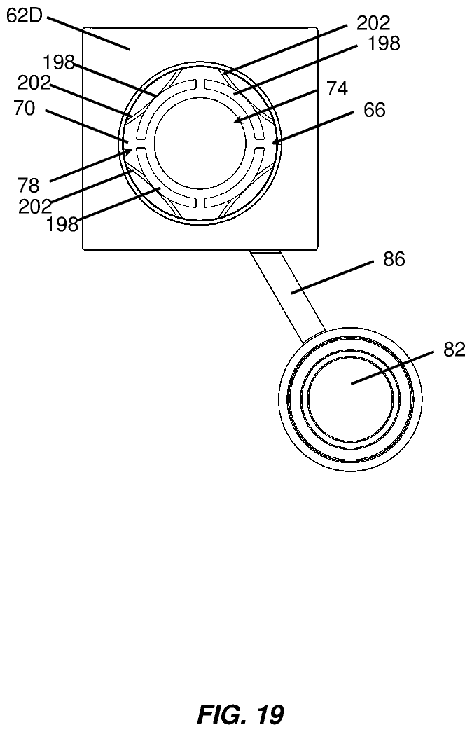

FIG. 19 shows an alternate embodiment of the inlet flange 62D. Unless otherwise noted, the inlet flange 62D includes the same structures and functionality noted above. The inlet flange 62D differs in the design of the clamp 78. The clamp 78 includes clamping arms 198 which are attached to the inlet flange 62D by spring arms 202. The clamping arms 198 and spring arms 202 are molded integrally with the inlet flange 62D. The spring arms 202 are somewhat flexible and may bend to allow the clamping arms 198 to expand apart from each other to allow the vacuum inlet 34 or the plug 82 to pass therethrough. The spring arms 202 then press the clamping arms 198 inwardly against the vacuum inlet 34 or plug 82 to retain the vacuum inlet 34 or plug 82 in place relative to the inlet flange 62D.

The above description of illustrated examples of the present invention, including what is described in the Abstract, are not intended to be exhaustive or to be limitation to the precise forms disclosed. While specific examples of the invention are described herein for illustrative purposes, various equivalent modifications are possible without departing from the broader scope of the present claims. Indeed, it is appreciated that specific example dimensions, materials, etc., are provided for explanation purposes and that other values may also be employed in other examples in accordance with the teachings of the present invention.

What is claimed is:

1. A vacuum filter bag comprising:
a flexible front layer;
a flexible back layer;
wherein the flexible front layer and the flexible back layer are attached together to form a filter bag;
wherein the filter bag comprises filter media of a porosity sufficient to filter dust from air flowing through the filter media;
a front layer opening formed in the filter bag front layer;
an inlet flange attached to the filter bag front layer at the front layer opening;
an inlet gasket attached to the inlet flange;
a filter inlet opening formed in the inlet gasket;
a plug which is attached to the inlet flange by a first flexible connector;
wherein the plug is sized and configured to engage the filter inlet gasket to thereby close the filter inlet opening;
a clamp which is connected to the inlet flange by a second flexible connector;
wherein the clamp is secured to the inlet flange in a position adjacent the filter inlet opening;
wherein the clamp is operable to grip a vacuum inlet when the filter bag is attached to a vacuum such that a vacuum inlet extends through the filter inlet opening; and
wherein the clamp is operable to grip the plug and thereby hold the plug in a position wherein the plug closes the filter inlet opening.

2. The vacuum filter bag of claim 1, wherein the clamp is selectively movable between a first position away from the inlet flange and a second position adjacent the inlet flange by bending the second flexible connector, and wherein the inlet clamp comprises fasteners which hold the clamp adjacent the inlet flange in the second position.

3. The vacuum filter bag of claim 2, wherein the inlet flange comprises retention clips which engage the clamp to secure the clamp adjacent the inlet flange in the second position.

4. The vacuum filter bag of claim 1, wherein the clamp comprises a first clamping arm and a second clamping arm which comprise a non-linear clamping face configured to engage opposing sides of a generally cylindrical section of a vacuum inlet tube, and wherein the first and second clamping arms are movable towards each other to grip a vacuum inlet tube.

5. The vacuum filter bag of claim 4, wherein the inlet flange further comprises a guide slot and wherein distal ends of the clamping arms extend through the guide slot and are movable within the guide slot, and wherein the guide slot secures the clamping arms adjacent the inlet flange.

6. The vacuum filter bag of claim 4, wherein the clamping arms comprise a clamping face comprising a material which is softer than a material forming the clamping arms.

7. The vacuum filter bag of claim 4, wherein the clamping arms comprise distal ends which include engagement features which interact with a fastener to hold the clamping arms towards each other.

8. The vacuum filter bag of claim 7, wherein the fastener comprises a strap which engages the distal ends of the clamping arms, and wherein the strap is attached to the filter inlet flange before use of the strap and is separated from the inlet filter flange before use of the strap.

9. The vacuum filter bag of claim 1, wherein the plug comprises a distal end, a chamfered shoulder disposed adjacent the distal end, a generally cylindrical clamping shoulder disposed proximally of the chamfered shoulder, and a flange which extends outwardly from a proximal end of the clamping shoulder.

10. A vacuum filter bag comprising:
a flexible front layer;
a flexible back layer;
wherein the flexible front layer and the flexible back layer are attached together to form a filter bag;
wherein the filter bag comprises filter media of a porosity sufficient to filter dust from air flowing through the filter media;
a front layer opening in the filter bag front layer;
an inlet flange attached to the filter bag front layer the front layer opening;
an inlet gasket attached to the inlet flange;
a filter inlet opening formed in the inlet gasket;
a clamp secured to the inlet flange in a position adjacent the filter inlet opening such that the clamp is operable to grip a vacuum inlet tube which extends through the filter inlet opening;
a plug which is sized and configured to engage the filter inlet gasket to thereby close the filter inlet opening; and
wherein the clamp is operable to grip the plug and thereby hold the plug in a position wherein the plug closes the filter inlet opening.

11. The vacuum filter bag of claim 10, wherein the plug comprises a distal end, a chamfered shoulder disposed adjacent the distal end, a generally cylindrical clamping shoulder disposed proximally of the chamfered shoulder, and a flange which extends outwardly from a proximal end of the clamping shoulder.

12. The vacuum filter bag of claim 10, wherein the clamp is attached to the inlet flange by a flexible connector and wherein the flexible connector is bendable to move the clamp between a first position away from the inlet flange and a second position adjacent the inlet flange, and wherein the inlet flange comprises fasteners which hold the clamp adjacent the inlet flange in the second position.

13. The vacuum filter bag of claim 12, wherein the inlet flange comprises retention clips which engage the clamp to secure the clamp adjacent the inlet flange in the second position.

14. The vacuum filter bag of claim 10, wherein the clamp comprises a first clamping arm and a second clamping arm which are positionable to engage opposing sides of a vacuum inlet tube, and wherein the first and second clamping arms are movable towards each other to grip a generally cylindrical section of a vacuum inlet tube.

15. The vacuum filter bag of claim 14, wherein the inlet flange further comprises a guide slot and wherein distal ends of the first and second clamping arms extend through the guide slot such that the guide slot secures the clamping arms adjacent the inlet flange, and wherein the distal ends of the clamping arms are movable within the guide slot to actuate the clamp.

16. The vacuum filter bag of claim 14, wherein the first and second clamping arms are generally rigid and wherein the first and second clamping arms each comprise a clamping face comprising a material which is softer than a material forming the first and second clamping arms.

17. The vacuum filter bag of claim 14, wherein the first and second clamping arms comprise distal ends which include engagement features which interact with a fastener to hold the first and second clamping arms towards each other.

18. A vacuum filter bag comprising:
a flexible front layer;
a flexible back layer;
wherein the flexible front layer and the flexible back layer are attached together to form a filter bag;
wherein the filter bag comprises filter media of a porosity sufficient to filter dust from air flowing through the filter media;
a front layer opening in the filter bag front layer;
an inlet flange attached to the filter bag front layer the front layer opening;
an inlet gasket attached to the inlet flange;
a filter inlet opening formed in the inlet gasket;
a clamp secured to the inlet flange in a position adjacent the filter inlet opening;
wherein the clamp comprises a first clamping arm and a second clamping arm which are configured to be positioned on opposite sides of a vacuum inlet tube within a vacuum canister;
wherein the clamp is operable to grip a generally cylindrical section of a vacuum inlet tube which extends through the filter inlet opening by moving the first clamping arm and the second clamping arm towards each other; and
wherein, during use of the vacuum filter bag, the first clamping arm and the second clamping arm are held against a vacuum inlet tube to secure the inlet flange to the vacuum tube inlet.

19. The vacuum filter bag of claim 18, further comprising a plug which is sized and configured to engage the filter inlet gasket to thereby close the filter inlet opening, and wherein the clamp is operable to grip the plug and thereby hold the plug in a position wherein the plug closes the filter inlet opening.

20. The vacuum filter bag of claim 18, wherein the clamp is attached to the inlet flange by a flexible connector and wherein the flexible connector is bendable to move the clamp between a first position away from the inlet flange and a second position adjacent the inlet flange, and wherein the inlet flange comprises retention fasteners which engage the clamp to secure the clamp in the second position adjacent the inlet flange.
